(19) United States
(12) Patent Application Publication
(10) Pub. No.: US 2002/0118102 A1
(43) Pub. Date: Aug. 29, 2002

(54) Boat security system

(76) Inventors: Ronald Fundak, Pompano Beach, FL (US); Rafael J. Picon, Boca Raton, FL (US)

Correspondence Address: Steven M. Greenberg, Akerman, Senterfitt & Eidson, P.A., Post Office Box 3188, West Palm Beach, FL, 33402-3188, US

(21) Appl. No.: 10/078,894

(22) Filed: Feb. 19, 2002

Related U.S. Application Data
(63) Continuation of application No. 09/023,633, filed on Feb. 13, 1998.

(51) Int. Cl. H04Q 1/30

(52) U.S. Cl. 340/311.2; 340/7.1

(57) ABSTRACT

A boat security system based on two-way paging technology to allow immediate notification of any abnormal situations that the boat owner chooses to monitor. In response to an abnormal condition, affirmative action may be taken such as generating an audible alarm, disabling the boat, or enabling a tracking device. The system communicates alarm condition employing the ReFLEX™ two way paging technology and, when coupled to an alphanumeric pager, allowing for reporting of status conditions of the boat can be obtained. The basic embodiment includes a alarm functions for the bilge including bilge cycles, battery strength, door and hatch sensors, a shock sensor for detecting an impact such as dock line breakage.

### CROSS REFERENCE TO RELATED APPLICATIONS

This is a continuation of pending application Ser. No. 09/023,633 filed Feb. 13, 1998.

### FIELD OF THE INVENTION

This invention relates generally to alarm systems and more particularly to an alarm system having two way communication specifically directed to boat security.

### BACKGROUND INFORMATION

It is well known that homes and boats are subject to theft. Home security is a basic concern and a large variety of home security systems exist to meet this concern. In many instances, such home systems have been adapted for use on a boat. However, home security systems are generally not suitable or even adequate for boats.

A boat is similar to a home in its ability to hold personal property. If a boat is used by live-aboards, the boat will house similar personal items as those kept in a land based home. In addition, boats carry very expensive electronic equipment necessary for safe navigation. For instance, a typical boat carries VHF radios, radar, GPS and/or LORAN locators, EPRIP's, depth/fish sounder, auto-pilot and so forth for purposes of operation. Ancillary equipment may include television, VCR, stereo, inflatable boats, wave runners, generators, dive gear, and so forth. Boats also have multiple engines, many of which are made of expensive corrosion resistant, explosion proof materials. For these reasons, boats of all sizes have a particular security problem.

According to the Boat Owners' Association of the United States, an average of 1,000 boats per month are stolen. The odds of recovering a stolen boat are only one in ten. Unlike a home, all personal property stored onboard can be stolen simultaneously by simply taking the boat. A boat is equipped with a complete propulsion system and the only item that secures a boat to dry land is nylon dock lines. Most boats have fully redundant propulsion systems and if one engine does not operate, a second system is available. However, even if both engines are disabled, the dock lines can be easily unfastened or cut and the boat floated away through the water. Even if a boat is stored on a trailer, a thief only needs an automobile to steal the boat.

Another security problem with boats that does not effect homes is the constant movement of a boat. A boat secured in a slip must have sufficient dock line length to accommodate tidal changes. If a boat is moored, it will swing throughout the day and may rotate 360 degrees during a tide change. While the enjoyment of a boat is the expected constant movement, such movement enhances the security problem making the adaptation of a home security system inappropriate.

A popular home base security system having real time monitoring requires a monthly fee be paid to an organization who will monitor the condition of the home while the security system is engaged. Some of these systems even employ private radio or cellular phones, all of which are costly to maintain and limited in coverage.

If a home monitoring system is adapted to a boat having a central office monitoring system, should the boat be broken into while at its assigned slip, the system may operate correctly. However, should the boat be moved or docked at a location other than its assigned slip, the police will go to the wrong location should an alarm situation occur. The use of a central office to cover such a system while in a remote area would require hiring of multiple monitoring services. In reality, the limited coverage makes it impractical for the average consumer to have real time monitoring.

Thus, what is needed is a security system that provides the advantages of real time monitoring without the associated costs of inherent problems with a central office monitoring system.

### SUMMARY OF THE INVENTION

The instant invention implements two-way paging technology in a security system for boats. The paging technology allows the boat owner immediate notification of any abnormal situation that the boat owner chooses to monitor. In addition, the owner may then take affirmative action such as generating an audible alarm, disabling the boat, or enabling a tracking device.

The system can instantly communicate an alarm condition via an electronic page. An alphanumeric pager allows a status of boat conditions to be accessed from any location. The boat security system is programmed with the phone number of the alphanumeric pager for receiving messages. Functions can be programmed using an integrated keypad which resides within a tamper protected enclosure hidden on the boat.

The basic embodiment includes alarm functions for the bilge including bilge cycles, battery strength, door and hatch sensors, a shock sensor for detecting an impact such as dock line breakage. In addition, a shock sensor can be calibrated to more sensitive settings to detect movement of a boat stored on a trailer. The system implements a NMEA 183 interface providing a connection to a GPS or Loran device to facilitate the recovery of the boat in the event it is stolen.

Once any of the above sensors causes a system processor to set an alarm event, the processor can drive one of the control outputs to turn on an audible siren, periodically sound a horn, disable the ignition or fuel systems, and so forth. The processor can also transmit a pre-saved text message for receipt by a narrow band PCS service provider in the area and forward it to the boat owner, potentially anywhere in the country.

In response to an alarm message, the boat owner can use any telephone to call the system. The owner may acknowledge the alarm, request a status message, or enable any of the control outputs to do one of the functions described above.

Thus, an objective of the instant invention is to teach a system that employs two-way paging to send alarm notices and receive instructions pertaining to boat security.

Another objective of the instant invention is to teach a system that uses two-way paging to send and receive text messages for disabling the ignition system or fuel system.

Still another objective of the instant invention is to teach a boat security system that uses two-way paging to send and receive messages for enabling lights, sirens or any audible horn and confirm receipt of an alarm message.

Yet still another objective of the instant invention is to teach a boat security system that uses two-way paging for use in providing a remote status report of all monitored systems.

Another objective of the instant invention is to teach a boat security system that uses two-way paging to enable a position reporting device such as a GPS receiver to provide position status.

Still another objective of the instant invention is to teach a boat security system that uses two-way paging capability to send messages regarding high water in a bilge, door opening; low battery voltage, mechanical shock detection, motion detector alert, smoke or fire alert.

Still another objective of the instant invention is to teach a boat security system that uses two-way paging to send text messages for receiving commands via the paging network for updating system microcode for upgrades or code fixes and control systems on the boat that have been wired for control.

Other objectives and advantages of this invention will become apparent from the following description taken in conjunction with the accompanying drawings wherein are set forth, by way of illustration and example, certain embodiments of this invention. The drawings constitute a part of this specification and include exemplary embodiments of the present invention and illustrate various objects and features thereof.

### BRIEF DESCRIPTION OF THE DRAWINGS

FIG. 1 is an exploded view of the circuit control box;

FIG. 2 is a block diagram of the invention; and

FIG. 3 is an electrical schematic of the invention.

### DETAILED DESCRIPTION OF THE INVENTION

Although the invention is described in terms of a specific embodiment, it will be readily apparent to those skilled in this art that various modifications, rearrangements and substitutions can be made without departing from the spirit of the invention. The scope of the invention is defined by the claims appended hereto.

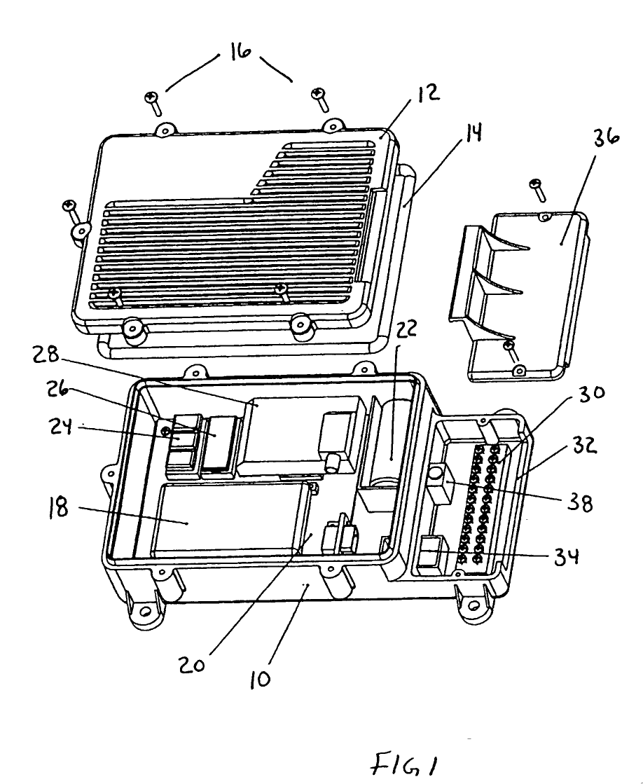

FIG. 1 depicts the tamper proof housing 10 of the instant invention formed from a compact water resistant housing capable of resisting the corrosive effects of moisture and salt water. The housing 10 includes a top cover 12 sealed by a neoprene seal 14 to the housing 12 by use of attachment screws 16. The housing 10 encompasses a two-way transceiver 18 with a PCB 20 powered from the boat battery, not shown, with a replaceable back-up battery 22 provided if the boat battery is exhausted or disconnected. A keypad 24 allows local programming of the system with a liquid crystal display 26 providing visual display. A GPS receiver 28 may be formed integral into the housing 10 for instant positioning of the boat. Sensor connections are made to the housing at terminal block 30 by use of cable port 32 and cable exit potting well 34. A terminal access cover 36 is positionable over the terminal block 30 with a reed switch 38 providing a tamper detection of the cable section.

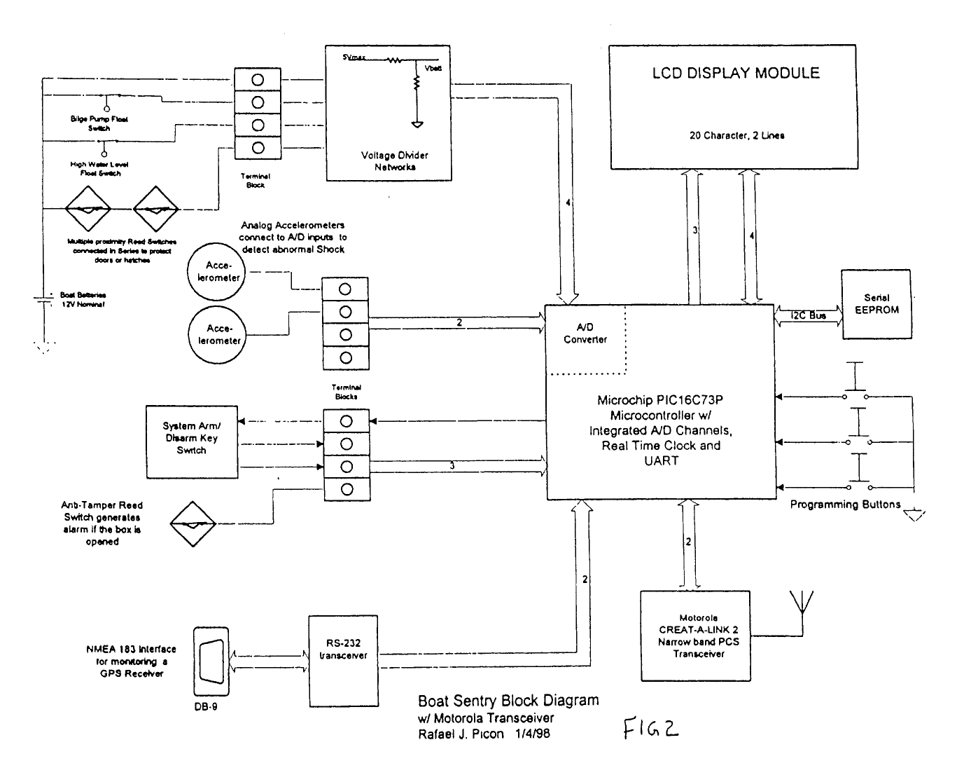

FIG. 2 is a block diagram of the invention and illustrates the central component of the circuit, namely, a PIC 16C73P microcontroller with integrated A/D converters, a real time clock, UART, and I2C interface. Two A/D converters are used to measure the “g” force experienced by accelerometers which are mounted in the gunwale of a boat. A third A/D converter will measure the voltage of the boat batteries. A voltage divider circuit is used to scale the battery voltage down to 5V for receipt by the microprocessor. Connection to bilge pump float provides the number of cycles and average “on” time of the bilge pump. A second float switch is placed at a higher point in the bilge to indicate a high water level. Both of these are connected through voltage divider networks to comply with the 5V signal requirements of the microprocessor. Magnetic reed switches can be connected in series to monitor hatches or doors.

A serial EEPROM is programmed using the I2C interface and used to store phone numbers, custom messages, and configuration settings such as the accelerometer threshold settings. Control box reed switch, as depicted by numeral 38, detects system box 10 tampering. It runs from the 5V supply, and thus does not need the voltage divider network.

The ReFLEX two way paging technology from MOTOROLA provides a narrow band PCS transceiver. An LCD display module coupled-to the microprocessor provides twenty characters over two lines and is enclosed within the housing 10. The programming buttons allow the system to be personalized or reprogrammed in the field.

The boat security system differs from available alarm systems in that it can instantly communicate an alarm condition via an electronic page. The two way paging technology allows for the transfer of information and may be coupled to a standard alphanumeric pager which allows a status of boat conditions to be monitored remotely from the boat.

Once installed, the boat security system is programmed with the phone number of the alphanumeric pager that will be receiving its messages. Several user preferences can also be set in the boat security system, these include the following:

How often “All is well” messages are sent (Daily, Twice a Day, weekly, not at all).

Which event/conditions will cause an alarm message to be sent.

Enable/Disable Repetitive Alarm messages until an acknowledge message is received.

Enable/Change/Disable passwords for acknowledge messages.

These functions can be programmed using an integrated keypad on the boat security system which resides beneath an access door that is protected by an anti-tamper switch.

The boat security system is armed and disarmed via a key switch using a single pole double throw switch that is pre-wired and potted in plastic. The three wires connected to the switch are the same color and attached inside the tamper proof access door. The boat security system will send and check a changing binary sequence on the wires, and will sense the inputs to minimize the chance that the switch can be bypassed.

The basic embodiment includes a mercury float switch that should be installed in the bilge area, a few inches higher than the automatic bilge pump switches. This switch will be wired to the High water alert input on the terminal block to operate switch S2, and will generate an alarm if activated. The bilge cycles input of the terminal block is connected to the positive wire of the automatic bilge pump. A 12V signal on this wire will indicate that the bilge pump is on. On cycles can be counted by the processor, and may be reported as status in the “All is well” messages. Alternately, excessive cycles can cause an alarm paging. The main battery input is used to sense and measure the battery voltage. The measured level will be included as status in the “All is well” messages, and an alarm message can be sent when the battery voltage drops below 11 Volts. In addition, the main battery input provides 12VDC to the boat security system for operation. If the Main Battery Input drops below 8VDC, then the system will switch to backup battery power, and will automatically send an alarm message. Furthermore, if the backup battery drops below 10VDC, at any time, an alarm message will be sent.

Several optional sensors will be available for the system. A magnetic door switch sensor that can be used on cabin doors or hatches is available. Multiple sensors of this type can be connected to the Magnetic switch Input of the terminal block. A shock sensor that can be used to detect an impact, can be calibrated to generate an alarm in the case of a sizable impact(s), as might be the case if a dock line breaks, or in the case of a collision with a passing boat. In addition, the shock sensor can be calibrated to a more sensitive setting to detect movement to a boat stored on a trailer. In this configuration, the system will detect if someone comes aboard, or if there is any tampering with an outboard engine. Other sensors that will be made available include a smoke detector for the engine or cabin compartments, a motion detector for the cabin compartment, and a strain gauge sensor. The latter will detect deflections at critical areas of the deck to determine that someone has come aboard.

The system implements a NMEA-183 listen only interface. This serial port allows connection to a GPS or Loran device. The system processor will extract the position data from the NMEA 183 data stream, and can provide periodic messages with that data to facilitate the recovery of the boat in the event it is stolen.

Once any of the above sensors causes the system processor to set an alarm event, it can drive one of the control outputs to turn on an audible Siren, periodically sound the horn, or even disable the ignition or fuel systems. It will also transmit a pre-saved text message using the built-in ReFlex pager transmitter. That signal will be received by the narrow band PCS service provider in the area in which the boat is docked. The message will then get forwarded to the boat owner, potentially anywhere in the country (if the alphanumeric pager is subscribed for national coverage).

In response to an alarm message, the boat owner can use any telephone to call the system. The owner may acknowledge the alarm, request a status message, or enable any of the control outputs to do one of the functions described above.

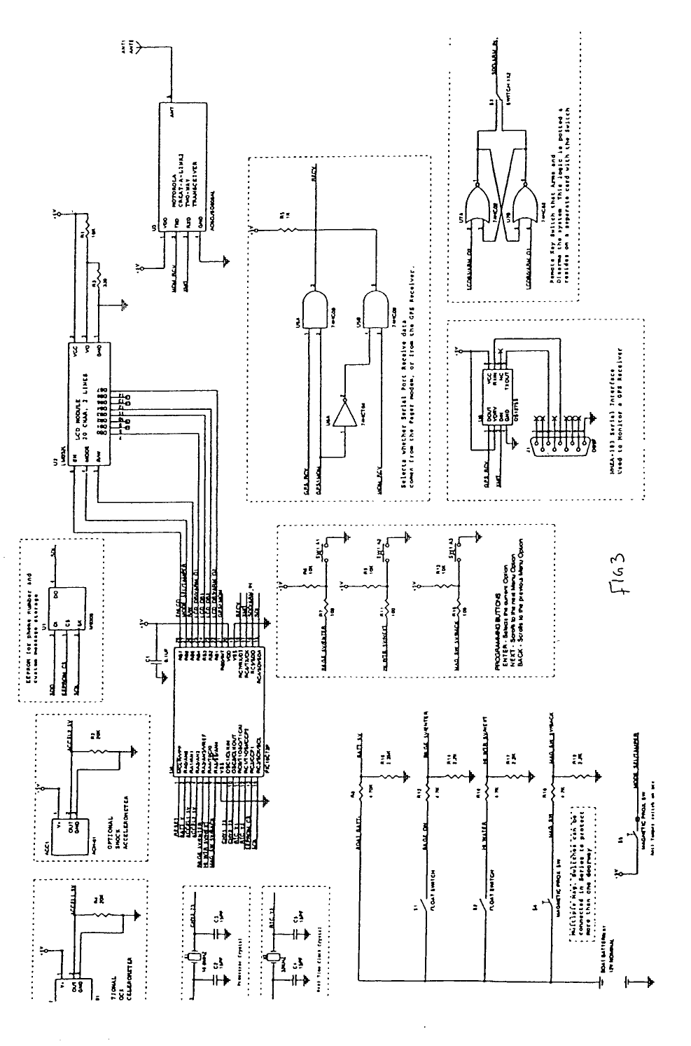

Now referring to FIG. 3, the security system is comprised of a set of circuits housed in a compact water resistant housing designed to resist the corrosive effects of moisture and exposure to salt water. The circuits an associated sensors and switches that are not contained within the housing. The central component of the circuit is the PIC micro processor (U4) such as PIC 16C73P which integrates several of the functions including A/D converters, a Real Time Clock, UART, and I2C interface.

Up to three A/D converters are implemented in the design. Two are used to measure the “g” force experienced by Accelerometers ACC1 and ACC2 mounted in the gunwale of a boat to detect excessive shock. The threshold for action can be set at the time of installation.

The third A/D will measure the voltage of the boat batteries. A voltage divider circuit is used to scale the battery voltage down to 5V for receipt by the processor. Connection to Float switch S1 provides the number of cycles and average “on” time of the bilge pump. This data can be used by preprogrammed software to predict if the boat is sinking. In addition, float switch S2 is placed at a higher point in the bilge, indicates that the water has risen well above normal, and immediate action is required. Both of these are connected through voltage divider networks to comply with the 5V signal requirements of the microcontroller.

S4 is representative of several magnetic reed switches that can be connected in Series to monitor hatches or doors. These reed switches connect to pin 7 of U4. Pins 5, 6, and 7 of the Microcontroller also serve a second function. When the system is disarmed, these inputs sample push button entries that are used to program options, and enter configuration data into the system. U1, a serial EEPROM, is programmed using the I2C interface of the Micro. The EEPROM Stores phone numbers, custom messages, and configuration settings such as the accelerometer threshold settings, S5 is a reed switch that detects tampering with the system box. It runs from the 5V supply, and thus does not need the voltage divider network.

The LCD module is enclosed within the outer cover of the box, and is only accessible when the cover is open. The data and control lines are only sampled by the LCD module on the rising and falling edges of the EN pin. For this reason, its control lines can be used for other functions when the system is Armed. Two of the LCD data lines are used to drive the Arm Switch. The Arm Switch is a Key lock switch that is installed in an accessible location. This allows the system to be Armed just prior to disembarking the craft, and disarmed, upon boarding the craft. A serial pattern is sent on pins ARM_O1 and ARM_O2. The ARM_IN in/put is sampled by the Micro to determine if the switch is in One position or the other. This design prevents an intruder from shorting the wires to disarm the system.

The UART in the Microcontroller is shared by the pager transceiver (U3), and the NMEA-183 interface supported through J1. The boat security system will default to always listening to the Pager transceiver for incoming messages. If directed to do so by an incoming message, it will periodically switch the multiplexer implemented with U5 and U6 to obtain coordinates from GPS receiver that can be connected to J1.

The boat security system of the instant invention thus discloses a method of interfacing a two-way pager communications-type device capable of sending and receiving data through a telephone communication system by first coupling the two-way pager commincations-type device to the security system which provides signals in response to preprogrammed alarm conditions and sending the digital data to said telephone communication system.

It is to be understood that while we have illustrated and described certain forms of my invention, it is not to be limited to the specific forms or arrangement of parts herein described and shown. It will be apparent to those skilled in the art that various changes may be made without departing from the scope of the invention and the invention is not to be considered limited to what is shown in the drawings and described in the specification.

What is claimed is:

1. A method of interfacing a two-way pager communications-type device which is capable of sending and receiving data through a telephone communication system, said system comprising:
coupling a two-way pager communications-type device to a security system, said security system having preprogrammed alarm conditions;
said step of coupling comprising converting each alarm condition into digital data;
sending the digital data to said telephone communication system.

2. The method of according to claim 1, wherein said step of coupling comprises providing two-way communications between said pager device and said telephone communication system.

3. The method of according to claim 1, wherein said step of sending comprising storing digital data in a microprocessor memory.

4. The method of according to claim 1, wherein said step of coupling further comprises transmitting each said digital converted data formed by said step of converting, said step of transmitting being carried out in response to said step of automatically determining, whereby, upon the receipt of an alarm conditions the two-way pager is actuated to transmit the digital data.

5. A method of interfacing a two-way pager communications-type device which is capable of sending and receiving data through a telephone communication system, said system comprising:
coupling a two-way pager communications-type device to a security system, said security system having alarm conditions;
said step of coupling comprising converting each alarm condition into digital data;
storing digital data in a microprocessor memory;
sending the digital data to said telephone communication system;
transmitting each said digital converted data formed by said step of converting, said step of transmitting being carried out in response to said step of automatically determining, whereby, upon the receipt of an alarm condition the two-way pager is actuated to transmit the digital data; and

6. The method of according to claim 5, wherein said step of coupling comprises providing two-way communications between said pager device and said telephone communication system.

7. The method of according to claim 5, wherein said alarm condition is a high water level in a bilge.

8. The method of according to claim 5, wherein said alarm condition is a door or hatch opening;

9. The method of according to claim 5, wherein said alarm condition is low battery voltage.

10. The method of according to claim 5, wherein said alarm condition is a mechanical shock detection.

11. The method of according to claim 5, wherein said alarm condition is an unwarranted motion.

12. The method of according to claim 5, wherein said alarm condition is smoke detection.

13. The method of according to claim 5, wherein each alarm condition is displayed on an alphanumerical pager having preprogrammed text.

14. The method of according to claim 5, wherein said step of receiving said digital data includes the step of converting said steps to trigger preprogrammed functions.

15. The method of according to claim 14, wherein said preprogrammed function disables an ignition system.

16. The method of according to claim 14, wherein said preprogrammed function enables an audible sound.

17. The method of according to claim 14, wherein said preprogrammed function enables lights.

18. The method of according to claim 5, wherein said step of receiving digital data includes a step of enabling a position reporting device and transmitting a position status.

19. The method of according to claim 5, wherein said step of transmitting digital data includes a step of transmitting a status report of all monitored systems

20. The method of according to claim 5, wherein said two way pager operates on ReFLEX™ protocol.

21. The method of according to claim 5, wherein said two way pager operates on cellular.

22. The method of according to claim 5, wherein said step of sending digital data includes a step of compiling a status of measured conditions on all monitored systems.

23. The method of according to claim 5, wherein said step of sending digital data is timed to be sent on a predetermined scheduled.
